(19) United States
(12) Patent Application Publication
(10) Pub. No.: US 2024/0241497 A1
(43) Pub. Date: Jul. 18, 2024

(54) IMAGING ENVIRONMENT ADJUSTING DEVICE, AND COMPUTER-READABLE STORAGE MEDIUM

(71) Applicant: FANUC CORPORATION, Yamanashi (JP)

(72) Inventors: Yuuki SUGITA, Yamanashi (JP); Nobuaki AIZAWA, Yamanashi (JP)

(21) Appl. No.: 18/556,674

(22) PCT Filed: May 14, 2021
(86) PCT No.: PCT/JP2021/018418

§ 371 Date: Oct. 23, 2023

(51) Int. Cl. G05B 19/402; G05B 19/406; G05B 19/408

(52) U.S. Cl. CPC G05B 19/402; G05B 19/406; G05B 19/408

(57) ABSTRACT

This imaging environment adjusting device comprises: a trigger detection unit which detects at least one type of trigger; a setting table which stores at least one environment setting item for defining an imaging environment for a processing machine; a determination result acquisition unit which acquires a determination result regarding whether to adjust the imaging environment so as to be in a control state specified by the at least one environment setting item; and an imaging environment adjusting unit which adjusts the imaging environment so as to be in the control state specified by the at least one environment setting item when the trigger detection unit detects at least one type of trigger and the determination result acquired by the determination result acquisition unit indicates to adjust the imaging environment.

### RELATED APPLICATIONS

The present application is a National Phase of International Application No. PCT/JP2021/018418 filed May 14, 2021.

### TECHNICAL FIELD

The present disclosure relates to an imaging environment adjustment device and a computer readable storage medium.

### BACKGROUND ART

Imaging devices that capture images inside a machining machine are conventionally known (Patent Literature 1). Such imaging devices capture an image of a part or the whole of a machining machine from a pre-set direction at a pre-set magnification.

### CITATION LIST

### Patent Literature

Patent Literature 1: Japanese Patent Application Laid-Open No. 2020-78833

### SUMMARY OF INVENTION

### Technical Problem

However, when an imaging device captures an image of a machining machine, the imaging environment is not always suitable for imaging. For example, even when an object to be imaged is a tool, the tool may be shielded by a coolant or the like, and this may prevent the imaging device from capturing an image of the tool.

The present disclosure intends to provide an imaging environment adjustment device and a computer readable storage medium that can adjust an imaging environment to a state suitable for imaging when an image of a machining machine is captured.

### Solution to Problem

An imaging environment adjustment device includes: a trigger detection unit that detects at least one type of trigger; a setting table that stores at least one environment setting item defining an imaging environment in a machining machine; a determination result acquisition unit that acquires a determination result as to whether or not to adjust the imaging environment into a control state indicated by the at least one environment setting item; and an imaging environment adjustment unit that, when the trigger detection unit detects the at least one type of trigger and the determination result acquired by the determination result acquisition unit indicates to adjust the imaging environment, adjusts the imaging environment into the control state indicated by the at least one environment setting item.

A computer readable storage medium stores an instruction that causes a computer to perform: detecting at least one type of trigger; acquiring a determination result as to whether or not to adjust an imaging environment into a control state indicated by at least one environment setting item defining the imaging environment in a machining machine; and when the at least one type of trigger is detected and the acquired determination result indicates to adjust the imaging environment, adjusting the imaging environment into the control state indicated by the at least one environment setting item.

### Advantageous Effects of Invention

One aspect of the present disclosure makes it possible to adjust an imaging environment to a state suitable for imaging when an image of a machining machine is captured.

### BRIEF DESCRIPTION OF DRAWINGS

FIG. 1 is a diagram illustrating an example of a hardware configuration of a machining machine.

FIG. 2 is a block diagram illustrating an example of functions of an imaging environment adjustment device.

FIG. 3 is a diagram illustrating an example of a setting table.

FIG. 4 is a flowchart illustrating an example of a process performed in the imaging environment adjustment device.

FIG. 5 is a block diagram illustrating an example of functions of the imaging environment adjustment device.

FIG. 6 is a diagram illustrating an example of a reception image displayed on a display screen.

### DESCRIPTION OF EMBODIMENTS

One embodiment of the present disclosure will be described below with reference to the drawings. Note that not all of the combined features described in the following embodiment are necessarily required for achieving the object. Further, detailed description than is needed may be omitted. Further, the description and the drawings of the following embodiment are provided for those skilled in the art to fully understand the present disclosure and are not intended to limit the claims.

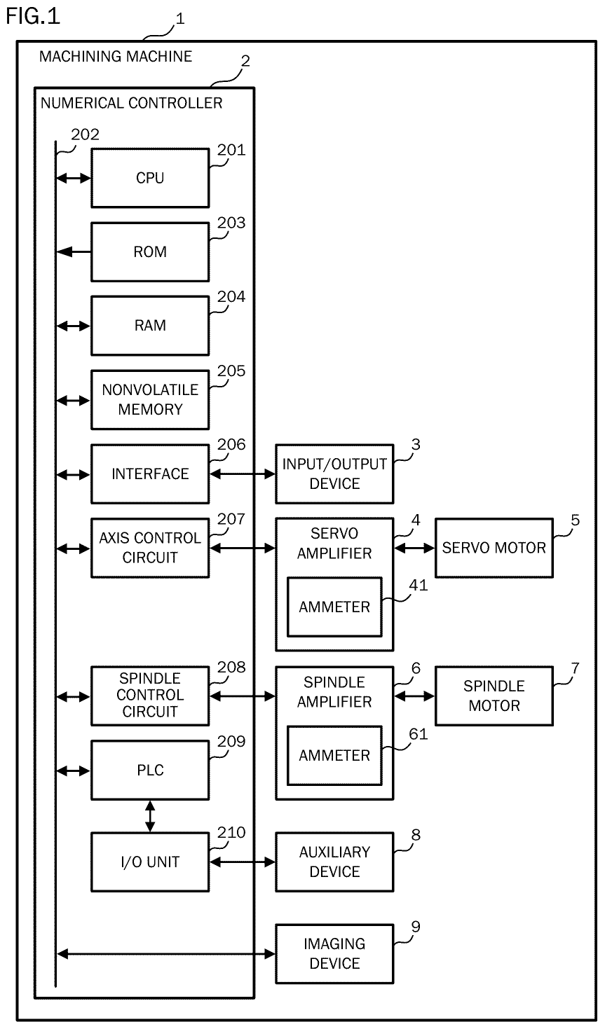

FIG. 1 is a diagram illustrating an example of a hardware configuration of a machining machine. For example, the machining machine 1 is a machine tool, a wire electrical discharge machine, or an injection molding machine. The machine tool includes a lathe, a machining center, and a multi-tasking machine.

The machining machine 1 includes a numerical controller 2, an input/output device 3, a servo amplifier 4 and a servo motor 5, a spindle amplifier 6 and a spindle motor 7, an auxiliary device 8, and an imaging device 9.

The numerical controller 2 has the functions of the imaging environment adjustment device of the present disclosure. That is, the imaging environment adjustment device is implemented on the numerical controller 2. In the following, an embodiment where the imaging environment adjustment device is implemented on the numerical controller 2 will be described. However, the imaging environment adjustment device may be implemented on a personal computer (PC) or a server.

The numerical controller 2 is a device that controls the overall machining machine 1. The numerical controller 2 has a central processing unit (CPU) 201, a bus 202, a read-only memory (ROM) 203, a random-access memory (RAM) 204, and a nonvolatile memory 205.

The CPU 201 is a processor that controls the overall numerical controller 2 in accordance with a system program. The CPU 201 reads a system program or the like stored in the ROM 203 via the bus 202 and performs various processes based on the system program. Further, the CPU 201 controls the servo motor 5 and the spindle motor 7 based on a machining program.

The CPU 201 performs, for example, analysis of a machining program and output of a control instruction to the servo motor 5 and the spindle motor 7 on a control cycle basis.

The bus 202 is a communication path connecting respective hardware components within the numerical controller 2 to each other. Respective hardware components within the numerical controller 2 transfer data to each other via the bus 202.

The ROM 203 is a storage device that stores a system program or the like used for controlling the overall numerical controller 2. The ROM 203 is a computer readable storage medium.

The RAM 204 is a storage device that temporarily stores various data. The RAM 204 functions as a work area where the CPU 201 processes various data.

The nonvolatile memory 205 is a storage device that holds data even when the machining machine 1 is powered off and the numerical controller 2 is not supplied with power. For example, the nonvolatile memory 205 stores a machining program and stores various parameters input from the input/output device 3. The nonvolatile memory 205 is a computer readable storage medium. The nonvolatile memory 205 is formed of a solid state drive (SSD), for example.

The numerical controller 2 further includes an interface 206, an axis control circuit 207, a spindle control circuit 208, a programmable logic controller (PLC) 209, and an I/O unit 210.

The interface 206 connects the bus 202 and the input/output device 3 to each other. For example, the interface 206 transmits various data processed by the CPU 201 to the input/output device 3.

The input/output device 3 is a device that receives various data via the interface 206 and displays the various data. Further, the input/output device 3 accepts input of various data and transmits the various data to the CPU 201 via the interface 206. The input/output device 3 includes a display such as a liquid crystal display (LCD), a keyboard, a mouse, and the like. The input/output device 3 may instead be a touch panel.

The axis control circuit 207 is a circuit that controls the servo motor 5. The axis control circuit 207 outputs an instruction for driving the servo motor 5 to the servo amplifier 4 in response to a control instruction from the CPU 201. For example, the axis control circuit 207 transmits a torque command used for controlling the torque of the servo motor 5 to the servo amplifier 4.

The servo amplifier 4 supplies current to the servo motor 5 in response to an instruction from the axis control circuit 207. The servo amplifier 4 has an ammeter 41 built in that measures a current value of current supplied to the servo motor 5.

The ammeter 41 determines a current value of current supplied to the servo motor 5. The ammeter 41 transmits data indicating a determined current value to the CPU 201.

The servo motor 5 is driven in response to being supplied with current from the servo amplifier 4. For example, the servo motor 5 is coupled to a ball screw that drives a tool post. When the servo motor 5 is driven, a structure of the machining machine 1, such as a tool post, moves in the X-axis direction, the Y-axis direction, or the Z-axis direction, for example. Note that a speed detector (not illustrated) that determines the feed rate of each control axis may be built in the servo motor 5.

The spindle control circuit 208 is a circuit for controlling the spindle motor 7. The spindle control circuit 208 outputs an instruction for driving the spindle motor 7 to the spindle amplifier 6 in response to a control instruction from the CPU 201. For example, the spindle control circuit 208 transmits a torque command used for controlling the torque of the spindle motor 7 to the spindle amplifier 6.

The spindle amplifier 6 supplies current to the spindle motor 7 in response to an instruction from the spindle control circuit 208. The spindle amplifier 6 has an ammeter 61 built in that measures a current value of current supplied to the spindle motor 7.

The ammeter 61 determines a current value of current supplied to the spindle motor 7. The ammeter 61 transmits data indicating a determined current value to the CPU 201.

The spindle motor 7 is driven in response to current supply from the spindle amplifier 6. The spindle motor 7 is coupled to a spindle and rotates the spindle.

The PLC 209 is a device that executes a ladder program to control the auxiliary device 8. The PLC 209 transmits an instruction to the auxiliary device 8 via the I/O unit 210.

The I/O unit 210 is an interface that connects the PLC 209 and the auxiliary device 8 to each other. The I/O unit 210 transmits an instruction received from the PLC 209 to the auxiliary device 8.

The auxiliary device 8 is a device installed in the machining machine 1 and configured to perform auxiliary operations in the machining machine 1. The auxiliary device 8 may be a device installed around the machining machine 1 instead of the device installed in the machining machine 1. The auxiliary device 8 operates based on an instruction received from the I/O unit 210. The auxiliary device 8 is, for example, a tool changer, a cutting fluid injector, or an opening/closing door drive device.

The imaging device 9 is a device that captures an image of the whole or a part of the machining machine 1. The imaging device 9 is a camera that captures moving images and still images. For example, the imaging device 9 starts capturing a moving image at a timing that execution of a machining program is started. For example, the imaging device 9 captures an image of a machining region of the machining machine 1.

For example, an image acquired by the imaging device 9 is stored in the nonvolatile memory 205 via the bus 202. Further, the imaging device 9 acquires time information together with an image. For example, the time information is a time of imaging being performed or an elapsed time from start of imaging.

Next, an example of functions of the imaging environment adjustment device implemented on the numerical controller 2 will be described.

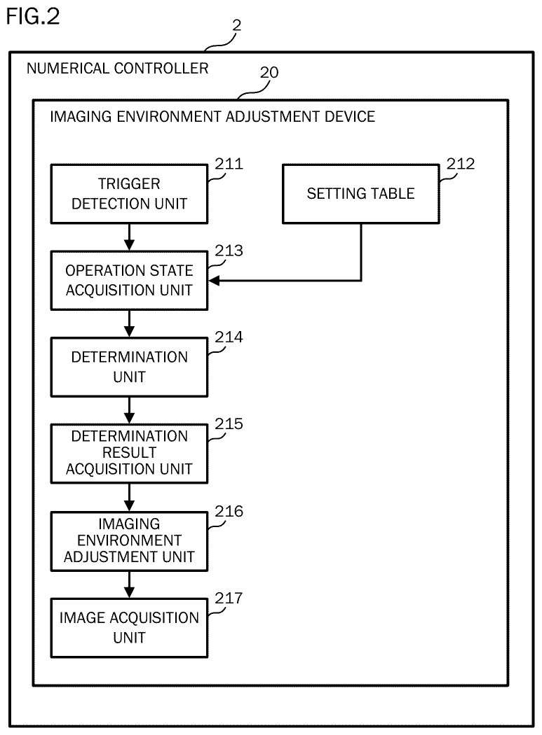

FIG. 2 is a block diagram illustrating an example of the functions of the imaging environment adjustment device. An imaging environment adjustment device 20 includes a trigger detection unit 211, a setting table 212, an operation state acquisition unit 213, a determination unit 214, a determination result acquisition unit 215, an imaging environment adjustment unit 216, and an image acquisition unit 217.

The trigger detection unit 211, the operation state acquisition unit 213, the determination unit 214, the determination result acquisition unit 215, the imaging environment adjustment unit 216, and the image acquisition unit 217 are implemented, for example, when the CPU 201 performs calculation processing by using a system program stored in the ROM 203 and various data stored in the nonvolatile memory 205.

The setting table 212 is implemented when data and parameters input from the input/output device 3 are stored in the RAM 204 or the nonvolatile memory 205, for example.

The trigger detection unit 211 detects at least one type of trigger. The trigger is a signal or an instruction that triggers the imaging environment adjustment device 20 to adjust an imaging environment. Further, the trigger may be a signal or an instruction that triggers the image acquisition unit 217 to acquire an image.

The signal or the instruction that triggers adjustment of an imaging environment is, for example, a signal output in response to an imaging button (not illustrated) being pressed, a signal indicating that a tool breakage alarm is issued, or a signal indicating that a workpiece loader alarm is issued. The trigger detection unit 211 detects a trigger, thereby the imaging environment is adjusted, and an image of the machining machine 1 is acquired.

The setting table 212 stores at least one environment setting item defining an imaging environment in the machining machine 1. The imaging environment represents a control state of the machining machine 1 that affects an image acquired by the image acquisition unit 217. That is, an imaging environment is formed by controlling the machining machine 1 into a control state stored as an environment setting item. Note that at least one type of trigger may include multiple types of triggers, and the setting table 212 may store at least one environment setting item in association with each of the multiple types of triggers.

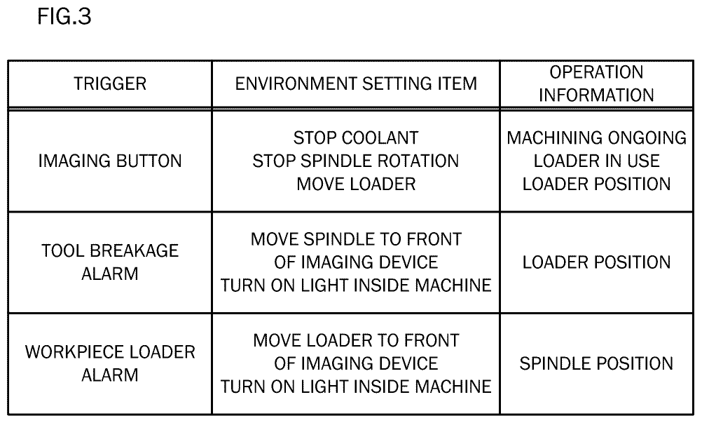

FIG. 3 is a diagram illustrating an example of the setting table 212. The setting table 212 stores environment setting items in association with each of the multiple types of triggers.

For “Imaging button”, environment setting items of “Stop coolant”, “Stop spindle rotation”, and “Move loader” are stored in association therewith. For “Tool breakage alarm”, environment setting items of “Move spindle to front of imaging device” and “Turn on light inside machine” are stored in association therewith. For “Workpiece loader alarm”, environment setting items of “Move loader to front of imaging device” and “Turn on light inside machine” are stored in association therewith.

The operation state acquisition unit 213 acquires operation information indicating an operation state of the machining machine 1 stored in association with at least one environment setting item applied when the trigger detection unit 211 detects at least one type of trigger.

As illustrated in FIG. 3, “Machining ongoing”, “Loader in use”, and “Loader position” are stored as the operation information in association with the environment setting items applied when pressing of the imaging button is detected as a trigger. Therefore, when pressing of the imaging button is detected as a trigger, the operation state acquisition unit 213 acquires information indicating whether or not a workpiece is being machined in the machining machine 1, information indicating whether or not the loader is in use, and information indicating the loader position.

Further, “Loader position” is stored as the operation information in association with the environment setting items applied when a tool breakage alarm is detected as a trigger. Therefore, when a tool breakage alarm is detected as a trigger, the operation state acquisition unit 213 acquires information indicating the loader position.

Further, “Spindle position” is associated with and stored in the environment setting items applied when a workpiece loader alarm is detected as a trigger. Therefore, when a workpiece loader alarm is detected as a trigger, the operation state acquisition unit 213 acquires information indicating the spindle position.

The determination unit 214 determines whether or not to adjust the imaging environment into the control state indicated by at least one environment setting item. The determination unit 214 determines whether or not to adjust the imaging environment based on the operation information acquired by the operation state acquisition unit 213. The determination unit 214 stores a determination result in a predetermined storage area (not illustrated).

For example, there is a case where pressing of the imaging button is detected by the trigger detection unit 211 and, as the operation information, the operation state acquisition unit 213 acquires information indicating that no workpiece is being machined. In such a case, no malfunction will occur even if ejection of the coolant is stopped and rotation of the spindle is stopped. Therefore, when the imaging button is pressed while no workpiece is being machined, the determination unit 214 determines to adjust the imaging environment into the control state stored in the environment setting item. That is, the determination unit 214 determines to stop the coolant and stop rotation of the spindle.

Further, there is a case where pressing of the imaging button is detected by the trigger detection unit 211 and, as the operation information, the operation state acquisition unit 213 acquires information indicating that the loader is not in use. In such a case, no malfunction will occur even if the loader is moved to its retracted position. Therefore, when the imaging button is pressed while the loader is not in use, the determination unit 214 determines to adjust the imaging environment into the control state stored in the environment setting item. That is, the determination unit 214 determines to move the loader to the retracted position.

Further, there is a case where pressing of the imaging button is detected by the trigger detection unit 211 and, as the operation information, the operation state acquisition unit 213 acquires information indicating that a workpiece is being machined. In such a case, if the ejection of the coolant were stopped, the temperature of a tool would rise resulting in a shorter tool lifetime. Therefore, when the imaging button is pressed while a workpiece is being machined, the determination unit 214 determines not to adjust the imaging environment into the control state stored in the environment setting item. That is, the determination unit 214 determines not to stop the coolant.

Further, there is a case where pressing of the imaging button is detected by the trigger detection unit 211 and, as the operation information, the operation state acquisition unit 213 acquires information indicating that a workpiece is being machined. In such a case, if the rotation of the spindle were stopped, a large load would be applied to a tool resulting in breakage of the tool. Therefore, when the imaging button is pressed while a workpiece is being machined, the determination unit 214 determines not to adjust the imaging environment into the control state stored in the environment setting item. That is, the determination unit 214 determines not to stop the rotation of the spindle.

Further, there is a case where pressing of the imaging button is detected by the trigger detection unit 211 and, as the operation information, the operation state acquisition unit 213 acquires information indicating that the loader is in use. In such a case, if the loader were moved to the retracted position, a workpiece would be unable to be handed over between the loader and the workpiece table. Otherwise, handover of a workpiece may fail. Therefore, when the imaging button is pressed while the loader is in use, the determination unit 214 determines not to adjust the imaging environment into the control state stored in the environment setting item. That is, the determination unit 214 determines not to move the loader.

Further, there is a case where pressing of the imaging button is detected by the trigger detection unit 211 and, as the operation information, the operation state acquisition unit 213 acquires information indicating that the loader is not in use and that the loader is located at a position to be included in an image. In such a case, the loader may block the field of view of the imaging device 9, and the tool to be imaged may fail to be included in the image. Therefore, when the imaging button is pressed while the loader is not in use and the loader is located at a position to be included in the image, the determination unit 214 determines to adjust the imaging environment into the control state set in the environment setting item. That is, the determination unit 214 determines to move the loader to the retracted position.

Further, there is a case where the tool breakage alarm is detected by the trigger detection unit 211 and, as the operation information, the operation state acquisition unit 213 acquires information indicating that the loader is at the retracted position. In such a case, no collision will occur between the spindle and the loader even if the spindle is moved close to the imaging device 9. Therefore, when the tool breakage alarm is detected while the loader is at the retracted position, the determination unit 214 determines to adjust the imaging environment into the control state stored in the environment setting item. That is, the determination unit 214 determines to move the spindle to the front of the imaging device 9. Note that, when the tool breakage alarm is detected by the trigger detection unit 211, the determination unit 214 determines to turn on the light inside the machine.

Further, there is a case where the tool breakage alarm is detected by the trigger detection unit 211 and, as the operation information, the operation state acquisition unit 213 acquires information indicating that the loader is not at the retracted position. In such a case, if the spindle were moved close to the imaging device 9, the spindle and the loader would collide with each other. Therefore, when the tool breakage alarm is detected while the loader is not at the retracted position, the determination unit 214 determines not to adjust the imaging environment into the control state stored in the environment setting item. That is, the determination unit 214 determines not to move the spindle to the front of the imaging device 9. Note that, even in such a case, the determination unit 214 determines to turn on the light inside the machine.

Further, there is a case where the workpiece loader alarm is detected by the trigger detection unit 211 and, as the operation information, the operation state acquisition unit 213 acquires information indicating that the spindle is at the retracted position. In such a case, no collision will occur between the loader and the spindle even if the loader is moved close to the imaging device 9. Therefore, when the workpiece loader alarm is detected while the spindle is at the retracted position, the determination unit 214 determines to adjust the imaging environment into the control state stored in the environment setting item. That is, the determination unit 214 determines to move the loader to the front of the imaging device 9. Note that, when the workpiece loader alarm is detected by the trigger detection unit 211, the determination unit 214 determines to turn on the light inside the machine.

Further, there is a case where the workpiece loader alarm is detected by the trigger detection unit 211 and, as the operation information, the operation state acquisition unit 213 acquires information indicating that the spindle is not at the retracted position. In such a case, if the loader were moved close to the imaging device 9, the loader and the spindle would collide with each other. Therefore, when the workpiece loader alarm is detected while the spindle is not at the retracted position, the determination unit 214 determines not to adjust the imaging environment into the control state stored in the environment setting item. That is, the determination unit 214 determines not to move the loader to the front of the imaging device 9. Note that, even in such a case, the determination unit 214 determines to turn on the light inside the machine.

The determination result acquisition unit 215 acquires a determination result whether or not to adjust the imaging environment into a control state indicated by at least one environment setting item. That is, the determination result acquisition unit 215 acquires a determination result determined by the determination unit 214. The determination result acquisition unit 215 reads a determination result stored in a predetermined storage area to acquire the determination result.

The imaging environment adjustment unit 216 adjusts the imaging environment into a control state indicated by at least one environment setting item when the trigger detection unit 211 detects at least one type of trigger and, further, the determination result acquired by the determination result acquisition unit 215 indicates to adjust the imaging environment. The imaging environment adjustment unit 216 adjusts the imaging environment based on the determination result acquired by the determination result acquisition unit 215. Note that, when the determination result acquired by the determination result acquisition unit 215 indicates not to adjust the imaging environment, the imaging environment adjustment unit 216 does not adjust the imaging environment. Further, when the determination result indicates to adjust the imaging environment by changing only some of the control states set in the environment setting items, the imaging environment adjustment unit 216 adjusts the imaging environment by changing some of the control states.

The image acquisition unit 217 acquires an image in an imaging environment adjusted by the imaging environment adjustment unit 216. When the imaging environment adjustment unit 216 does not adjust the imaging environment, the image acquisition unit 217 acquires an image in the unadjusted imaging environment. The image acquisition unit 217 acquires an image captured by the imaging device 9. For example, the image acquisition unit 217 outputs an imaging start instruction to the imaging device 9 and acquires at least either one of a moving image or a still image captured by the imaging device 9.

An image captured by the image acquisition unit 217 may be stored in the image storage unit (not illustrated). Further, an image acquired by the image acquisition unit 217 may be displayed on the display screen of the input/output device 3 by a display unit (not illustrated), for example.

Next, an example of the process performed in the imaging environment adjustment device 20 will be described.

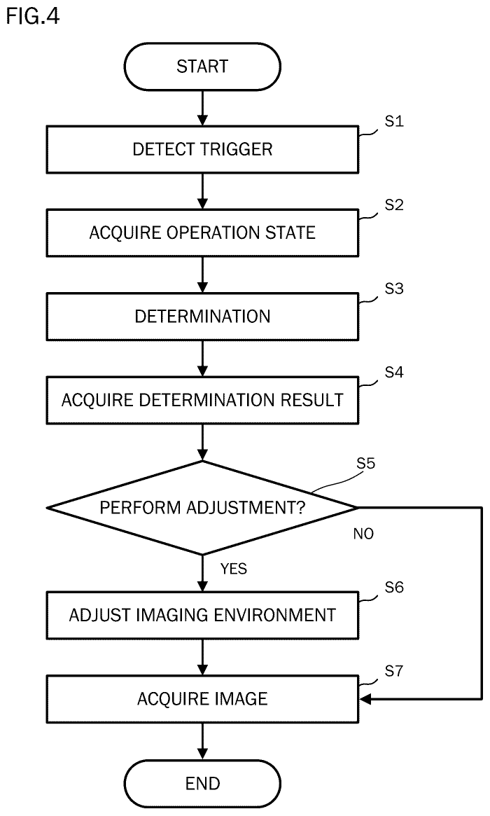

FIG. 4 is a flowchart illustrating an example of the process performed in the imaging environment adjustment device 20.

When machining is being performed with the numerical controller 2, the trigger detection unit 211 detects a trigger for adjusting an imaging environment (step S1).

Next, the operation state acquisition unit 213 acquires information indicating an operation state of the machining machine 1 indicated by operation information stored in a setting table in association with the trigger (step S2).

Next, the determination unit 214 determines whether or not to adjust the imaging environment into a control state set in the environment setting item based on the information indicating the operation state acquired by the operation state acquisition unit 213 (step S3).

Next, the determination result acquisition unit 215 acquires the determination result determined by the determination unit 214 as to whether or not to adjust the imaging environment (step S4).

If the determination result indicates to adjust the imaging environment (Yes in step S5), the imaging environment adjustment unit 216 adjusts the imaging environment (step S6).

Finally, the image acquisition unit 217 acquires an image under the imaging environment adjusted by the imaging environment adjustment unit 216 (step S7) and ends the process.

In contrast, if the determination result indicates not to adjust the imaging environment (No in step S5), the image acquisition unit 217 acquires an image under the unadjusted imaging environment (step S7) and ends the process.

Note that, although the image acquisition unit 217 acquires an image captured by the imaging device 9 in the embodiment described above, the imaging environment adjustment device 20 is not necessarily required to include the image acquisition unit 217. For example, the imaging environment adjustment device 20 may end the process after adjusting the imaging environment. In such a case, the operator can capture an image inside the machining machine 1 by a camera after the imaging environment is adjusted.

As described above, the imaging environment adjustment device 20 includes: the trigger detection unit 211 that detects at least one type of trigger; the setting table 212 that stores at least one environment setting item defining an imaging environment in the machining machine 1; the determination result acquisition unit 215 that acquires a determination result as to whether or not to adjust the imaging environment into a control state indicated by the at least one environment setting item; and the imaging environment adjustment unit 216 that, when the trigger detection unit 211 detects the at least one type of trigger and, further, the determination result acquired by the determination result acquisition unit 215 indicates to adjust the imaging environment, adjusts the imaging environment into the control state indicated by the at least one environment setting item.

Therefore, when capturing an image of the machining machine 1, the imaging environment adjustment device 20 can adjust the imaging environment into a state suitable for the image capturing. As a result, an object to be imaged can be reliably captured.

Further, the imaging environment adjustment device 20 further includes a determination unit 214 that determines whether or not to adjust the imaging environment into the control state indicated by the at least one environment setting item, and the determination result acquisition unit 215 acquires the determination result from the determination unit 214. Therefore, the imaging environment adjustment device 20 can automatically determine whether or not to adjust the imaging environment to adjust the imaging environment.

Further, at least one type of trigger includes multiple types of triggers, and the setting table 212 stores the at least one environment setting item in association with each of the multiple types of triggers. Therefore, the imaging environment adjustment device 20 can adjust the imaging environment to be adapted for each of the plurality of triggers.

Further, the imaging environment adjustment device 20 further includes an operation state acquisition unit 213 that acquires operation information indicating an operation state of a machining machine 1 stored in association with the at least one environment setting item applied when the trigger detection unit 211 detects the at least one type of trigger, and the determination result acquisition unit 215 acquires the determination result determined based on the operation information. Therefore, the determination unit 214 can determine whether or not to adjust the imaging environment in accordance with the operation state of the machining machine 1.

In the embodiment described above, when the trigger detection unit 211 detects a trigger, the imaging environment adjustment unit 216 moves the spindle or the loader to the retracted position. However, the imaging environment adjustment unit 216 may move a table or a robot to its retracted position without being limited to the spindle or the loader. For example, when the object to be imaged is a workpiece, the spindle, the robot, and the loader may be moved to their retracted positions.

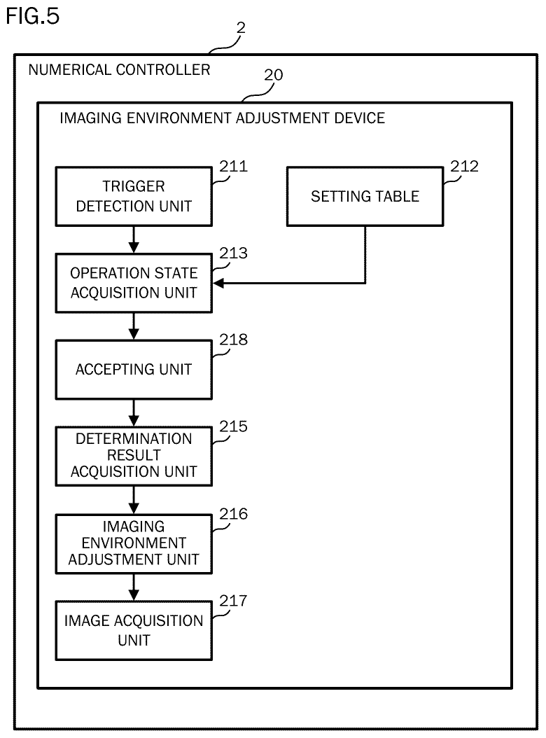

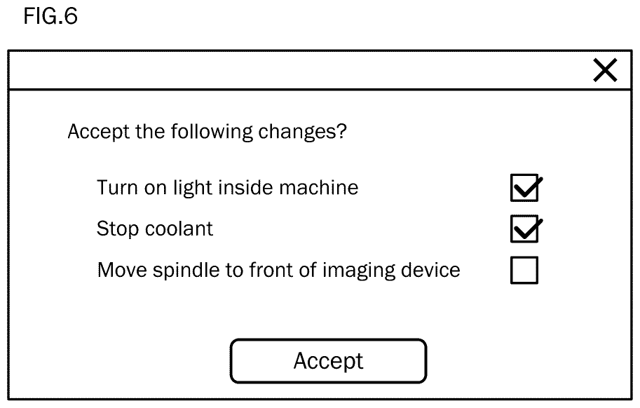

In the embodiment described above, the determination unit 214 determines whether or not to adjust the imaging environment into a control state indicated by at least one environment setting item. However, the determination as to whether or not to adjust the imaging environment into a control state indicated by at least one environment setting item may be made by a person such as an operator. An example in which a person makes a determination as to whether or not to adjust the imaging environment will be described with reference to FIG. 5 and FIG. 6.

FIG. 5 is a block diagram illustrating an example of the functions of the imaging environment adjustment device 20. The imaging environment adjustment device 20 illustrated in FIG. 5 includes an accepting unit 218 instead of the determination unit 214 illustrated in FIG. 2. The functions other than the accepting unit 218 are the same as the functions of respective units of the imaging environment adjustment device 20 of FIG. 2.

The accepting unit 218 accepts input of a determination result indicating whether or not to adjust the imaging environment into a control state indicated by at least one environment setting item. For example, the accepting unit 218 displays a reception image for accepting entry of a determination result on the display screen of the input/output device 3.

FIG. 6 is a diagram illustrating an example of the reception image displayed on the display screen. In the example illustrated in FIG. 6, “Turn on light inside machine”, “Stop coolant”, and “Move spindle to front of imaging device” are stored as environment setting items. The accepting unit 218 displays, on the display screen, a reception image for inputting whether or not to adjust the imaging environment into the control state indicated by these environment setting items. For example, once pressing the imaging button to cause this reception image to be displayed on the display screen, the operator determines whether or not to adjust the imaging environment into the control state indicated by each environment setting item and inputs a determination result via the reception image. Accordingly, the accepting unit 218 accepts the determination result.

The determination result acquisition unit 215 acquires the determination result from the accepting unit 218. This enables the operator to decide which item of the environment setting items to change.

Note that the present disclosure is not limited to the embodiment described above and can be changed as appropriate within the scope not departing from the spirit thereof. In the present disclosure, modification of any component of the embodiment or omission of any component of the embodiment is possible.

1. An imaging environment adjustment device comprising:
a trigger detection unit that detects at least one type of trigger;
a setting table that stores at least one environment setting item defining an imaging environment in a machining machine;
a determination result acquisition unit that acquires a determination result as to whether or not to adjust the imaging environment into a control state indicated by the at least one environment setting item; and
an imaging environment adjustment unit that, when the trigger detection unit detects the at least one type of trigger and the determination result acquired by the determination result acquisition unit indicates to adjust the imaging environment, adjusts the imaging environment into the control state indicated by the at least one environment setting item.

2. The imaging environment adjustment device according to claim 1 further comprising a determination unit that determines whether or not to adjust the imaging environment into the control state indicated by the at least one environment setting item,
wherein the determination result acquisition unit acquires the determination result from the determination unit.

3. The imaging environment adjustment device according to claim 1 further comprising an accepting unit that accepts input of the determination result indicating whether or not to adjust the imaging environment into the control state indicated by the at least one environment setting item,
wherein the determination result acquisition unit acquires the determination result from the accepting unit.

4. The imaging environment adjustment device according to claim 1,
wherein the at least one type of trigger includes multiple types of triggers, and
wherein the setting table stores the at least one environment setting item in association with each of the multiple types of triggers.

5. The imaging environment adjustment device according to claim 1 further comprising an operation state acquisition unit that acquires operation information indicating an operation state of a machining machine stored in association with the at least one environment setting item applied when the trigger detection unit detects the at least one type of trigger,
wherein the determination result acquisition unit acquires the determination result determined based on the operation information.

6. The imaging environment adjustment device according to claim 5,
wherein the operation information includes position information indicating a position of at least any one of a tool spindle, a table, a robot, and a loader, and
wherein the imaging environment adjustment unit moves at least any one of the tool spindle, the table, the robot, and the loader to a retracted position based on the position information.

7. The imaging environment adjustment device according to claim 1 further comprising an image acquisition unit that acquires an image in the imaging environment adjusted by the imaging environment adjustment unit.

8. A computer readable storage medium storing an instruction that causes a computer to perform:
detecting at least one type of trigger,
acquiring a determination result as to whether or not to adjust an imaging environment into a control state indicated by at least one environment setting item defining the imaging environment in a machining machine; and
when the at least one type of trigger is detected and the acquired determination result indicates to adjust the imaging environment, adjusting the imaging environment into the control state indicated by the at least one environment setting item.
